(19) United States
(12) Patent Application Publication
(10) Pub. No.: US 2017/0318620 A1
(43) Pub. Date: Nov. 2, 2017

(54) Connected Mode Discontinuous Reception for Narrow Band Internet of Things

(71) Applicant: MEDIATEK INC., Hsinchu (TW)

(72) Inventors: Li-Chuan Tseng, Hsinchu City (TW); Per Johan Mikael Johansson, Kungsangen (SE)

(21) Appl. No.: 15/498,763

(22) Filed: Apr. 27, 2017

Related U.S. Application Data
(60) Provisional application No. 62/328,637, filed on Apr. 28, 2016.

(51) Int. Cl. H04W 76/04; H04W 72/04; H04L 1/18; H04W 88/02

(52) U.S. Cl. CPC H04W 76/048; H04W 72/0446; H04L 1/1812; H04W 72/042; H04W 88/02

(57) ABSTRACT

A novel and efficient DRX operation mechanism is proposed to maintain the reliability and energy efficiency for NB-IOT systems. In NB-IOT systems, the length of a NB-PDCCH (with repetition) and the interval between two NB-PDCCHs are extended and can be reconfigured by eNB for each UE. The eNB can also adaptively adjusts the DRX parameters accordingly. NB-IOT UE monitors the NB-PDCCH in DRX ON duration, which is configured in number of NB-PDCCHs. Specifically, if a DRX timer duration is configured by the eNB in units of a PDCCH period, the UE should calculate the timer in terms of number of PDCCH user-specific search spaces (USSs), or in terms of PDCCH subframes by multiplying the number of PDCCH periods with the PDCCH repetition level.

### CROSS REFERENCE TO RELATED APPLICATIONS

This application claims priority under 35 U.S.C. §119 from U.S. Provisional Application No. 62/328,637 entitled “Connected Mode DRX for NB-IOT,” filed on Apr. 28, 2016, the subject matter of which is incorporated herein by reference.

### TECHNICAL FIELD

The disclosed embodiments relate generally to connected mode discontinuous reception (DRX), and, more particularly, to connected mode DRX design for Narrow Band Internet of Things (NB-IoT).

### BACKGROUND

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs) according to a predefined radio frame format. Typically, the radio frame format contains a sequence of radio frames, each radio frame having the same frame length with the same number of subframes. The subframes are configured for UE to perform uplink (UL) transmission or downlink (DL) reception in different Duplexing methods. Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE networks, Physical Downlink Control Channel (PDCCH) is used for dynamic downlink scheduling.

To enable reasonable UE battery consumption, discontinuous reception (DRX) operation in E-UTRAN is defined. UE may be configured via radio resource control (RRC) signalling with a DRX functionality that controls the UE's PDCCH monitoring activity for UE's C-RNTI, TPC-PUCCH-RNTI, TPC-PUSCH-RNTI and Semi-Persistent Scheduling C-RNTI (if configured). When in RRC CONNECTED mode, if DRX is configured, UE is allowed to monitor the PDCCH discontinuously using the DRX operation. Otherwise, UE monitors the PDCCH continuously. The DRX parameters are configured by eNodeB, a trade-off between UE battery saving and latency reduction.

The following definitions may apply to DRX operation in E-UTRAN: 1) on-duration: a duration in downlink subframes that the UE waits for, after waking up from DRX, to receive PDCCHs. If the UE successfully decodes a PDCCH, the UE stays awake and starts the inactivity timer; 2) inactivity-timer: a duration in downlink subframes that the UE waits to successfully decode a PDCCH, from the last successful decoding of a PDCCH, failing which it re-enters DRX. The UE shall restart the inactivity timer following a single successful decoding of a PDCCH for a first transmission only (i.e. not for retransmissions); 3) active-time: the total duration that the UE is awake. This includes the “on-duration” of the DRX cycle, the time UE is performing continuous reception while the inactivity timer has not expired and the time UE is performing continuous reception while waiting for a DL retransmission after one HARQ RTT. Based on the above, the minimum active time is of length equal to on-duration, and the maximum active time is undefined.

Narrowband IoT (NB-IoT) is a Low Power Wide Area Network (LPWAN) radio technology standard that has been developed to enable a wide range of devices and services to be connected using cellular telecommunications bands. NB-IoT is a narrowband radio technology designed for the Internet of Things (IoT), and is one of a range of Mobile IoT (MIoT) technologies standardized by the 3GPP. NB-IOT aims at supporting large number of low-cost, low-power IOT devices. Considering the factors including traffic pattern, bandwidth, and battery life requirements, PDCCH transmission needs to be redesigned for NB-IOT, and connected-mode DRX operation needs modifications accordingly to maintain the reliability and energy efficiency for NB-IOT systems.

### SUMMARY

A method of supporting discontinuous reception (DRX) operation for monitoring physical downlink control channel (PDCCH) in narrowband Internet of Things NB-IOT systems is proposed. A novel and efficient DRX operation mechanism is proposed to maintain the reliability and energy efficiency for NB-IOT systems. In NB-IOT systems, the length of a NB-PDCCH (with repetition) and the interval between two NB-PDCCHs are extended and can be reconfigured by eNB for each UE. The eNB can also adaptively adjusts the DRX parameters accordingly. NB-IOT UE monitors the NB-PDCCH in DRX ON duration, which is configured in number of NB-PDCCHs. Specifically, if a DRX timer duration is configured by the eNB in units of a PDCCH period, the UE should calculate the timer in terms of number of PDCCH user-specific search spaces (USSs), or in terms of PDCCH subframes by multiplying the number of PDCCH periods with the PDCCH repetition level.

In one embodiment, a UE receives a control signal for configuring a number of narrowband physical downlink control channel (NB-PDCCH) periods that carry downlink control information (DCI). Each NB-PDCCH period refers to an interval between the start of two consecutive NB-PDCCH occasions. The UE configures discontinuous reception (DRX) parameters for DRX operation in radio resource control (RRC) connected mode. The UE determines a NB-PDCCH user-specific search space (USS) for each NB-PDCCH period, wherein each NB-PDCCH USS comprises a repetition level of NB-PDCCH subframes for NB-PDCCH transmission. The UE monitors the DCI for a monitoring time such that the UE monitors a total number of NB-PDCCH USSs during an On Duration of each DRX cycle.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network supporting discontinuous reception (DRX) operation with narrowband physical downlink control channel (NB-PDCCH) monitoring in accordance with one novel aspect.

FIG. 2 illustrates simplified block diagrams of a base station and a user equipment in accordance with embodiments of the present invention.

FIG. 3 illustrates a signaling flow between a base station and a user equipment for configuration DRX parameters with NB-PDCCH monitoring.

FIG. 4 illustrates one example of periodic NB-PDCCH monitoring and DRX operation.

FIG. 5 illustrates NB-PDCCH monitoring behavior and DRX parameter configuration based on absolute time duration and number of NB-PDCCH subframes.

FIG. 6 is a flow chart of a method of connected mode DRX operation with NB-PDCCH monitoring by NB-IoT devices in accordance with one novel aspect.

### DETAILED DESCRIPTION

Reference will now be made in detail to some embodiments of the invention, examples of which are illustrated in the accompanying drawings.

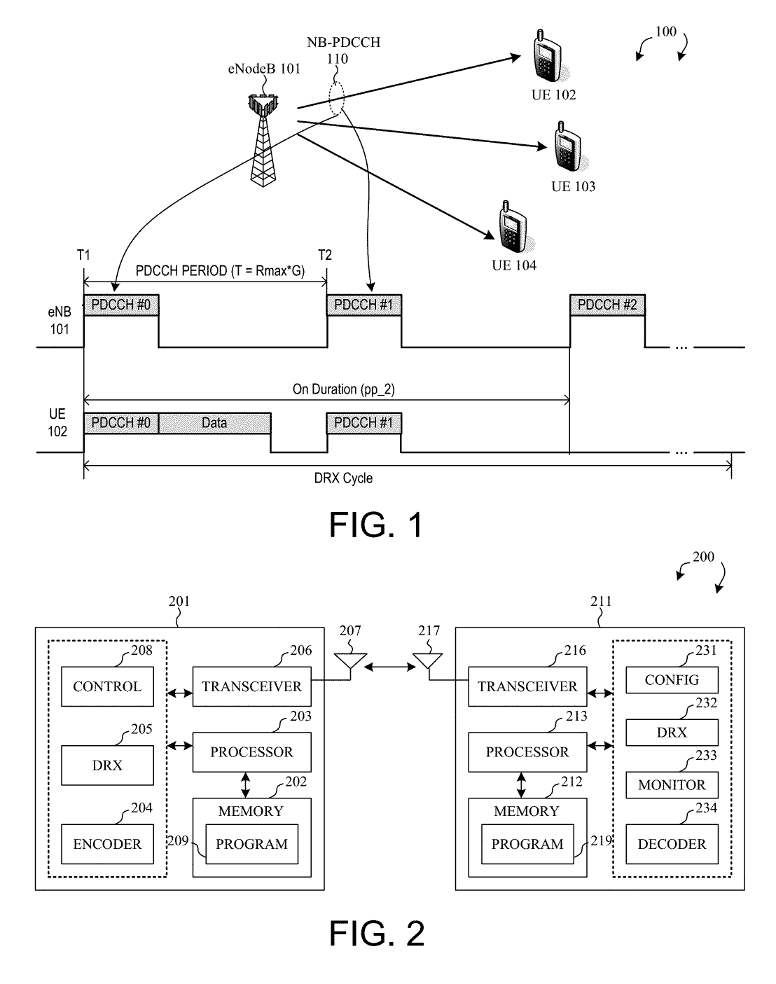

FIG. 1 illustrates a mobile communication network 100 supporting discontinuous reception (DRX) operation with narrowband physical downlink control channel (NB-PDCCH) monitoring in accordance with one novel aspect. Mobile communication network 100 is an OFDM/OFDMA system comprising a base station eNodeB 101 and a plurality of user equipment UE 102, UE 103, and UE 104. When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. The UE gets the downlink or uplink scheduling information from a physical downlink control channel (PDCCH) that is targeted specifically to that UE. In addition, broadcast control information is also sent in PDCCH to all UEs in a cell. The downlink or uplink scheduling information and the broadcast control information, carried by PDCCH, is referred to as downlink control information (DCI).

NB-IoT is a narrowband radio technology designed for the Internet of Things (IoT), and is one of a range of Mobile IoT (MIoT) technologies standardized by the 3GPP. NB-IOT aims at supporting large number of low-cost, low-power IOT devices. In FIG. 1, a narrowband downlink control channel (NB-PDCCH) 110 is used for eNodeB 101 to send DCI to the UEs. In 3GPP LTE systems based on OFDMA downlink, the radio resource is partitioned into subframes, each of which is comprised of two slots and each slot has seven OFDMA symbols along time domain. Each OFDMA symbol further consists of a number of OFDMA subcarriers along frequency domain depending on the system bandwidth. In the current LTE systems, each subframe has one PDCCH, PDCCH monitoring is configured in number of subframes and each UE monitors every PDCCH. In NB-IOT systems, however, due to much narrower bandwidth and the requirement of coverage extension, the NB-PDCCH transmission scheme is redesigned. The length of a NB-PDCCH (with repetition) and the interval between two NB-PDCCHs are extended and can be reconfigured by the eNB. The transmission duration of NB-PDCCH becomes much longer, especially with large number of repetitions. As a result, the NB-PDCCH monitoring behavior needs to be redesigned for NB-IOT, and timers control to monitoring NB-PDCCH also needs to be extended.

Connected mode discontinuous reception (DRX) is supported for NB-IOT. In accordance with one novel aspect, a novel and efficient DRX operation mechanism is proposed to maintain the reliability and energy efficiency for NB-IOT systems. There are some major differences between NB-IOT and current LTE. First, NB-IOT has much narrower bandwidth (200 KHz) and the support of coverage enhancement, meaning the transmissions of common control signaling may occupy more than one subframes. Second, a large number (>50,000) NB-IOT UEs in a cell is to be supported, which means that the scheduling information of each UE can be carried by a subset of PDCCHs, and a UE needs not to monitor all PDCCHs transmitted by the eNB. Third, NB-IOT has traffic pattern with infrequent and small data, implying that most of the time a NB-IOT UE is monitoring the control channel instead of transmitting or receiving data. In summary, for the narrower bandwidth and large number of UEs, it is beneficial to modify the DRX parameter configuration so that a UE is requested to monitor a given number of PDCCHs for different coverage level. In addition, the PDCCH monitoring behaviors are adjusted to match the new DRX configurations. For power saving purpose, a NB-IOT UE may sleep most of the time and turn on its receiver discontinuously to monitor PDCCH for potential scheduling opportunities.

In the example of FIG. 1, eNB 101 configures periodic PDCCH user search space (USS) for UE 102. Each PDCCH USS comprises a number of subframes with repetitive PDCCH transmission, e.g., repetition level R=Rmax. For example, if Rmax=256, then it means that the DCI will be repeated transmitted over 256 consecutive subframes, i.e., one PDCCH USS occupies 256 ms. UEs in good coverage is configured with lower repetition level or smaller repetition number, while UEs in poor coverage is configured with higher repetition level or larger repetition number. Each PDCCH USS is also referred to as a PDCCH occasion, e.g., PDCCH occasion starts at time T1 for PDCCH#0, and PDCCH occasion starts at time T1 for PDCCH#1. Further, a PDCCH period is defined as the time interval between the start of two consecutive PDCCH occasions, e.g., time interval T from T1 to T2. Each PDCCH period (PP) can be specified in unit of T=Rmax*G (subframes), where G is the PDCCH interval coefficient, which indicates the ratio of the entire PDCCH period and the PDCCH USS length. In one example, if Rmax=256, G=1.5, then PDCCH USS length=256, PDCCH period T=384, in the unit of subframes.

When eNB 101 configures DRX operation for UE 102, the DRX parameters are configured in proper units, e.g., absolute time, number of PDCCH periods to be monitored, or number of PDCCH subframes to be received. Based on different PDCCH configurations, eNB can further adjust the DRX parameters for each UE. In one example, eNB configures the DRX cycle to be 2048 subframes, and DRX On-Duration to be two PDCCH periods (pp_2=2T). When UE receives the DRX configuration, it calculates the starting point of the UE-specific search space for each PDCCH and monitors two PDCCH USSs accordingly. Although the DRX cycle and offset may be configured in terms of absolute time, the absolute time for UE to monitor PDCCH may vary, and may be longer than 2T=768 ms. In one example, the UE extends the monitoring time when some subframes within a NB-PDCCH USS are reserved for non-PDCCH transmission. In another example, the UE extends the monitoring time when a NB-PDCCH USS is located at the end of a hyper frame.

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules and circuits to carry out some embodiments of the present invention. The different functional modules and circuits can be configured and implemented by software, firmware, hardware, or any combination thereof. The function modules and circuits, when executed by the processors 203 and 213 (e.g., via executing program codes 209 and 219), for example, allow base station 201 to encode and transmit downlink control information to UE 211, and allow UE 211 to receive and decode the downlink control information accordingly. In one example, base station 201 configures for NB-PDCCH transmission via control module 208, configures for DRX operation via DRX module 205. The downlink control information carried in NB-PDCCH is then modulated and encoded via encoder 204 to be transmitted by transceiver 206 via antenna 207. UE 211 receives NB-PDCCH and DRX configuration by transceiver 216 via antenna 217. UE 211 obtains NB-PDCCH configuration via configuration circuit 231, performs DRX operation via DRX circuit 232, and monitors NB-PDCCH via monitor 233 based on the NB-PDCCH and DRX configuration accordingly. UE 211 then demodulates and decodes the downlink control information via decoder 234 for subsequent operation.

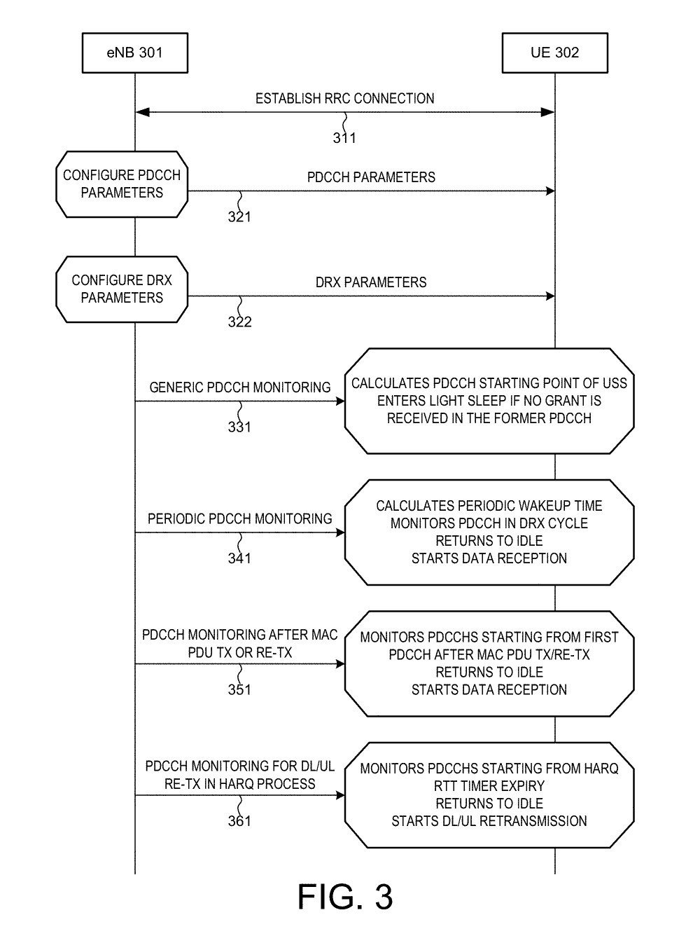

FIG. 3 illustrates a signaling flow between a base station eNB 301 and a user equipment UE 302 for configuration DRX parameters with NB-PDCCH monitoring. In step 311, eNB 301 and UE 302 establish a radio resource control (RRC) connection. In step 321, eNB 302 configures PDCCH parameters for UE 302 and transmits the PDCCH parameters to UE 302. The PDCCH parameters may include the PDCCH repetition number and PDCCH interval coefficient for NB-IOT UEs in different coverage level. In step 322, eNB 301 configures DRX parameters for UE 302 and transmits the DRX parameters to UE 302. The DRX parameters may include DRX cycle, DRX offset, DRX On-Duration, and DRX Inactivity-Timer, etc. The UE-specific DRX cycle and offset are configured in absolute time durations. DRX ON Duration, Inactivity-Timer, and DL/UL retransmission timer can be configured in number of PDCCH periods. Furthermore, the eNB can adaptively adjust the DRX parameters based on information including traffic load of each UE, PDCCH repetition number, and PDCCH interval coefficient. UE 302 can autonomously ignore the DRX configuration if the PDCCH period is longer than the DRX cycle.

NB-IOT UE 302 monitors the PDCCH for potential scheduling opportunities in different scenarios. Step 331 depicts generic PDCCH monitoring behavior for all scenarios. First, UE 302 calculates the starting point of the UE-specific search space of each PDCCH. Second, UE 302 enters light sleep between two PDCCHs if no grant is received in the former PDCCH. Step 341 depicts periodic PDCCH monitoring by UE 302 in RRC connected mode. First, UE calculates periodic wakeup time in each DRX cycle using a modulo formula. Second, UE monitors PDCCHs in each DRX cycle, starting from the first PDCCH after calculated wakeup time. Third, UE returns to idle when pre-configured number of PDCCHs (i.e. ON duration) are received. Finally, UE starts data reception if DL grant is found in PDCCH. Step 351 depicts PDCCH monitoring after each MAC PDU transmission or retransmission. First, UE monitors PDCCHs, starting from the first PDCCH after each MAC PDU transmission or retransmission. Second, UE returns to idle after pre-configured number of PDCCHs are received (i.e. inactivity timer expiry). Third, UE starts data reception if DL grant is received in a PDCCH. Step 361 depicts PDCCH monitoring for DL and UL retransmission in HARQ process. First, UE monitors PDCCHs for grants for DL or UL retransmission, starting from HARQ RTT timer expiry. Second, UE returns to idle after pre-configured number of PDCCHs are received, and the HARQ attempt is considered failed. Third, UE starts DL/UL retransmission if DL/UL grant is received in a PDCCH.

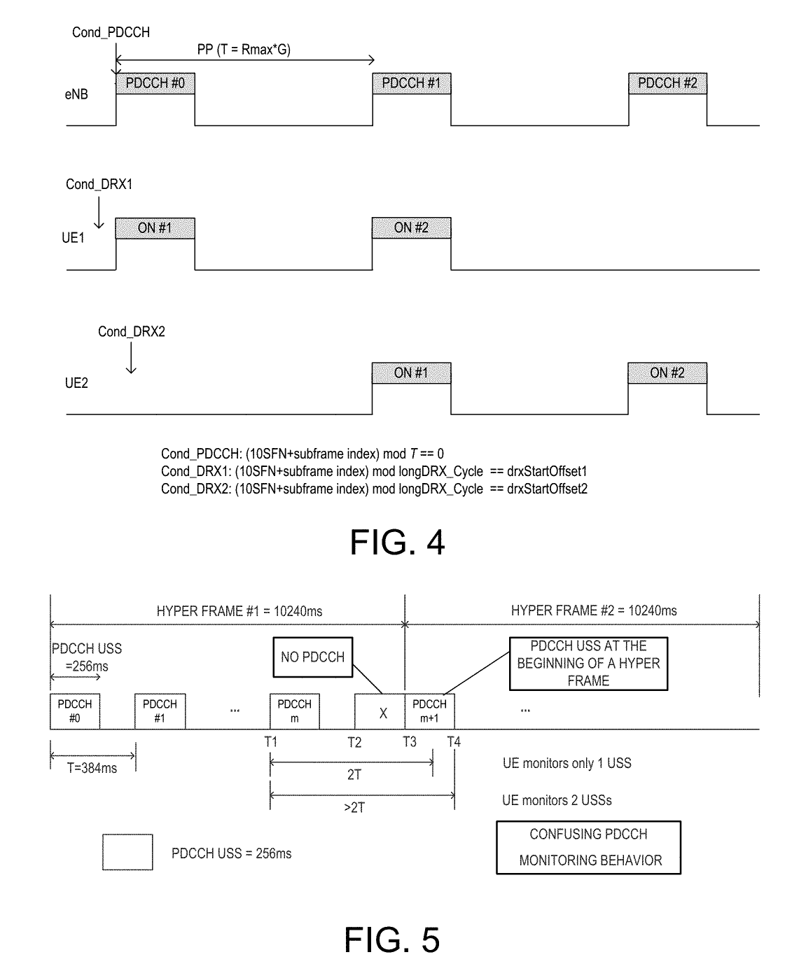

FIG. 4 illustrates one example of periodic NB-PDCCH monitoring and DRX operation. In the example of FIG. 4, eNB configures PDCCH periodically. Each PDCCH has a repetition level of Rmax, and an interval coefficient of G. As a result, each PDCCH period (PP) has a duration of T=Rmax*G between two consecutive PDCCH occasions. The eNB also configures DRX operation for UE1 and UE2. Typically, the eNB configures the DRX cycle and offset properly so that the starting point of drx-onDurationTimer aligns with that of PDCCH UE-specific search space. For drx-InacitivtyTimer and drx-retransmissionTimer, when UE needs to continue PDCCH monitoring after a transmission, UE should start PDCCH monitoring at the first PDCCH occasion 4 ms after HARQ feedback and/or PUSCH uplink transmission, i.e., after RTT timer expiry.

If the DRX cycle or offset is not configured properly, then there is confusion of PDCCH monitoring due to alignment issue. To solve such issue, the UE-specific DRX cycle and offset are configured in absolute time duration, e.g., T=Rmax*G=384 ms. On the other hand, DRX ON duration, inactivity timer, and downline and uplink retransmission timers are configured in terms of number of PDCCHs, e.g., number of PDCCH periods. In addition, UE calculates periodic wakeup time in each DRX cycle using a modulo formula. For example,

Cond_PDCCH:(10SFN+subframe index)mod T==0;

Cond_DRX1:(10SFN+subframe index)mod longDRX_Cycle==drxStartOffset1;

Cond_DRX2:(10SFN+subframe index)mod longDRX_Cycle==drxStartOffset2;

FIG. 5 illustrates NB-PDCCH monitoring behavior and DRX parameter configuration based on absolute time duration and number of NB-PDCCH subframes. When a timer is configured in terms of a number of PDCCH period (pp_n), its duration in time is given by pp_n*T, where T=Rmax*G(ms) indicates the length of one PDCCH period. In some cases, the PDCCH monitoring behavior can be confusing if the timer is configured in terms of absolute time, e.g., pp_2*T(ms). This is because the interval between the starting points of two consecutive PDCCH USSs may not be equal to T, in the case of (1) T>10.24 s, or (2) two PDCCH USSs are located in different hyper frames. To solve such confusion, if a timer duration is configured by upper layers in units of a PDCCH period, the UE should calculate the timer in terms of number of PDCCH USSs, or in terms of PDCCH subframes by multiplying the number of PDCCH periods (pp_n) with the PDCCH repetition level.

In the example of FIG. 5, PDCCH-USS=Rmax=256 ms, pp=T=Rmax*G=384 ms, eNB configures the DRX ON duration for UE to be two PDCCH periods, e.g. pp_2=2, and drx-onDurationTimer=pp_2*T=2T. Upon receiving the DRX configuration, UE will monitor PDCCH for 2T=768 (ms) during DRX ON duration, which typically result in monitoring two PDCCH USSs. However, if PDCCH m is located at the end of Hyper frame #1 starting at time T1, then there is no PDCCH subframes at time T2 after one PDCCH period of 384 ms. Instead, the next PDCCH m+1 starts at the beginning of the next Hyper frame #2 at time T3. It can be seen that if the UE monitors PDCCH for absolute time interval 2T starting from time T1, then the UE can only monitor one PDCCH USS (e.g., PDCCH m). In accordance with one novel aspect, the UE will not monitor PDCCH based on the absolute time interval of 2T. Instead, UE will extend the PDCCH monitoring time until the UE has completed monitoring two PDCCH USSs. For example, since there are no PDCCH subframes from time T2 to T3, the UE extends its PDCCH monitoring time to T4. As a result, the UE is able to monitor for two PDCCH USSs (e.g., PDCCH m and PDCCH m+1). Therefore, by using the number of PDCCH USSs or PDCCH subframes, the UE can extend its timer accordingly and be able to consistently monitor pp_n configured number of PDCCH USSs in DRX ON duration.

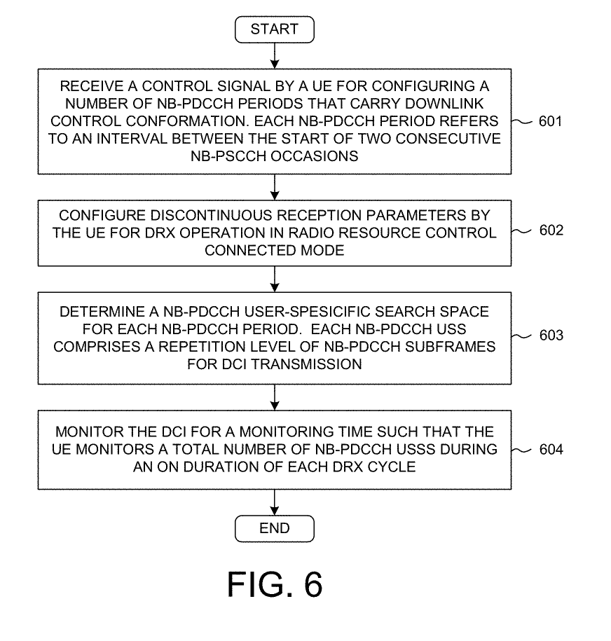

FIG. 6 is a flow chart of a method of connected mode DRX operation with NB-PDCCH monitoring by NB-IoT devices in accordance with one novel aspect. In step 601, a UE receives a control signal for configuring a number of narrowband physical downlink control channel (NB-PDCCH) periods that carry downlink control information (DCI). Each NB-PDCCH period refers to an interval between the start of two consecutive NB-PDCCH occasions. In step 602, the UE configures discontinuous reception (DRX) parameters for DRX operation in radio resource control (RRC) connected mode. In step 603, the UE determines a NB-PDCCH user-specific search space (USS) for each NB-PDCCH period, wherein each NB-PDCCH USS comprises a repetition level of NB-PDCCH subframes for NB-PDCCH transmission. In step 604, the UE monitors the DCI for a monitoring time such that the UE monitors a total number of NB-PDCCH USSs during an On Duration of each DRX cycle.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a control signal by a user equipment (UE) for configuring a number of narrowband physical downlink control channel (NB-PDCCH) periods that carry downlink control information (DCI), wherein each NB-PDCCH period refers to an interval between the start of two consecutive NB-PDCCH occasions;
configuring discontinuous reception (DRX) parameters by the UE for DRX operation in radio resource control (RRC) connected mode;
determining a NB-PDCCH user-specific search space (USS) for each NB-PDCCH period, wherein each NB-PDCCH USS comprises a repetition level of NB-PDCCH subframes for NB-PDCCH transmission; and
monitoring the DCI for a monitoring time such that the UE monitors a total number of NB-PDCCH USSs during an On Duration of each DRX cycle.

2. The method of claim 1, wherein the total number of NB-PDCCH subframes equals to the number of configured PDCCH periods multiplied by the repetition level.

3. The method of claim 1, wherein the monitoring time equals to the number of configured PDCCH periods multiplied by a time duration for each PDCCH period.

4. The method of claim 3, wherein the UE extends the monitoring time when some subframes within a NB-PDCCH USS are reserved for non-PDCCH transmission.

5. The method of claim 3, wherein the UE extends the monitoring time when a NB-PDCCH USS is located at the end of a hyper frame.

6. The method of claim 1, wherein the UE enters light sleep between two consecutive NB-PDCCHs when no grant is received in the former PDCCH.

7. The method of claim 1, wherein the UE periodically monitors the NB-PDCCHs by calculating wakeup time in each DRX cycle using a modulo formula.

8. The method of claim 7, wherein the UE enters idle mode when the total number of NB-PDCCH subframes are monitored and no grant is received.

9. The method of claim 1, wherein the UE monitors the NB-PDCCHs after each media access control (MAC) protocol data unit (PDU) transmission or retransmission.

10. The method of claim 1, wherein the UE monitors the NB-PDCCHs for retransmission in a hybrid automatic retransmission (HARQ) process.

11. A user equipment (UE) comprising:
a receiver that receives a control signal for configuring a number of narrowband physical downlink control channel (NB-PDCCH) periods that carry downlink control information (DCI), wherein each NB-PDCCH period refers to an interval between the start of two consecutive NB-PDCCH occasions;
a configuration circuit that configures discontinuous reception (DRX) parameters by the UE for DRX operation in radio resource control (RRC) connected mode; and
a monitoring circuit that determines a NB-PDCCH user-specific search space (USS) for each NB-PDCCH period, wherein each NB-PDCCH USS comprises a repetition number of NB-PDCCH subframes for NB-PDCCH transmission, and wherein the UE monitors the DCI for a monitoring time such that the UE monitors a total number of NB-PDCCH USSs during an On Duration of each DRX cycle.

12. The UE of claim 11, wherein the total number of NB-PDCCH subframes equals to the number of configured PDCCH periods multiplied by the repetition number.

13. The UE of claim 11, wherein the monitoring time equals to the number of configured PDCCH periods multiplied by a time duration for each PDCCH period.

14. The UE of claim 13, wherein the UE extends the monitoring time when some subframes within a NB-PDCCH USS are reserved for non-PDCCH transmission.

15. The UE of claim 13, wherein the UE extends the monitoring time when a NB-PDCCH USS is located at the end of a hyper frame.

16. The UE of claim 11, wherein the UE enters light sleep between two consecutive NB-PDCCHs when no grant is received in the former PDCCH.

17. The UE of claim 11, wherein the UE periodically monitors the NB-PDCCHs by calculating wakeup time in each DRX cycle using a modulo formula.

18. The UE of claim 17, wherein the UE enters idle mode when the total number of NB-PDCCH subframes are monitored and no grant is received.

19. The UE of claim 11, wherein the UE monitors the NB-PDCCHs after each media access control (MAC) protocol data unit (PDU) transmission or retransmission.

20. The UE of claim 11, wherein the UE monitors the NB-PDCCHs for retransmission in a hybrid automatic retransmission (HARQ) process.
